(19) United States
(12) Patent Application Publication
(10) Pub. No.: US 2022/0168945 A1
(43) Pub. Date: Jun. 2, 2022

(54) BONDING APPARATUS AND BONDING METHOD

(71) Applicant: HONDA MOTOR CO., LTD., Tokyo (JP)

(72) Inventors: Daisuke NAKAGAWA, Tochigi (JP); Kazuki MIYAMOTO, Tochigi (JP)

(21) Appl. No.: 17/426,103

(22) PCT Filed: Jan. 27, 2020
(86) PCT No.: PCT/JP2020/002767

§ 371 Date: Jul. 28, 2021

(30) Foreign Application Priority Data
Jan. 28, 2019 (JP) 2019-012030

(51) Int. Cl. B29C 51/10; B29C 51/16

(52) U.S. Cl. CPC B29C 51/10; B29L 2031/30; B29C 51/16

(57) ABSTRACT

A bonding apparatus 1 bonds a film F to a workpiece W, and is provided with a box body B for gripping the film F, a lower vacuum chamber 32 and an upper vacuum chamber 22 demarcated by the film F, an air pressure adjustment device 5 for adjusting the air pressure in the vacuum chambers 22, 32, a movement mechanism 6 for moving the workpiece W, and a control device 7 for controlling the air pressure adjustment device 5 and the movement mechanism 6. The control device 7 reduces the pressure inside the vacuum chambers 22, 32 to a first pressure, then increases the pressure inside the upper vacuum chamber 22 to a second air pressure in a state in which the film F and the workpiece W are brought into contact, and then increases the pressure inside the vacuum chambers 22, 32 to atmospheric pressure.

### TECHNICAL FIELD

The present invention relates to a bonding apparatus and bonding method. More specifically, the present invention relates to a bonding apparatus and bonding method for bonding a thin-membrane-shaped bonding member to a bonding target member.

### BACKGROUND ART

In recent years, thin-membrane-shaped films may be bonded to vehicle parts such as the roof, outer side panels, bonnet, and doors, etc. to improve the quality of the design of vehicles. In order to make films closely adhere to uneven shapes present in the surfaces of vehicle parts, vacuum bonding methods have been proposed, in which the film is bonded to a non-adhesive member in a vacuum.

For example, in the bonding method of Patent Document 1, the non-adhesive member is provided with a recessed receiving jig enclosing portion of the vehicle part from the inside of the portion to which the film is to be bonded, thereby defining a lower space between the receiving jig and the film, and an upper space between an upper box and the film. Further, in this bonding method, air pressure in the lower space and upper space is reduced to form a vacuum in these spaces, after which only the upper space is opened to the atmosphere to bond the film to the non-adhesive member.

Patent Document 1: Japanese Unexamined Patent Application, Publication No. 2015-44285

### DISCLOSURE OF THE INVENTION

### Problems to be Solved by the Invention

In this way, the bonding method of Patent Document 1 requires a vacuum to be formed in the lower space, which requires that the gap between the receiving jig and the vehicle part be sealed. However, since the shapes of vehicle parts manufactured by press molding or the like have remarkable irregularities, a packing task in which the gap between the receiving jig and the vehicle part is sealed by tape or the like is often performed manually by a worker. Further, in the bonding method of Patent Document 1, there is a need to support the vehicle part by means of the receiving jig in order to prevent deformation of the vehicle part when only the upper space is opened to the atmosphere.

The present invention has an object of providing a bonding apparatus and bonding method that do not require a jig for suppressing deformation of a bonding target member or a manual packing task, etc.

### Means for Solving the Problems

(1) A bonding apparatus according to the present invention (for example, a bonding apparatus 1 described below) bonds a thin-membrane-shaped bonding member (for example, a film F described below) to a bonding target member (for example, a workpiece W described below), and includes: a box body (for example, a box body B described below) configured to grip the bonding member inside the box body; a first chamber (for example, a lower vacuum chamber 32 described below) and a second chamber (for example, an upper vacuum chamber 22 described below) demarcated by the bonding member inside the box body; an air pressure adjustment device (for example, an air pressure adjustment device 5 described below) configured to adjust an air pressure in the first and second chambers; a movement mechanism (for example, a movement mechanism 6 described below) configured to move the bonding target member inside the first chamber; and a control device (for example, a control device 7 described below) configured to control the air pressure adjustment device and the movement mechanism, wherein the control device reduces the air pressure in the first and second chambers to a predetermined first air pressure lower than atmospheric pressure, then increases the air pressure in the second chamber to a second air pressure higher than the first air pressure and lower than atmospheric pressure in a state in which the bonding member and the bonding target member are brought close to each other, and then increases the air pressure in the first and second chambers to atmospheric pressure.

(2) A bonding apparatus according to the present invention (for example, a bonding apparatus 1A described below) bonds a thin-membrane-shaped bonding member (for example, a film F described below) to a bonding target member (for example a workpiece W described below), and includes: a small box body (for example, a small box 2A described below) configured to grip an edge portion of the bonding member; a big box body (for example, a big box 3A described below) having a first chamber (for example, a big chamber 32A described below) configured to house the bonding target member and the small box body; an air pressure adjustment device (for example, an air pressure adjustment device 5A described below) configured to adjust an air pressure in the first chamber and an air pressure in a second chamber (for example, a small chamber 22A described below) demarcated by the bonding member inside the small box body; a movement mechanism (for example, a movement mechanism 6A described below) configured to move the small box body or the bonding target member inside the first chamber; and a control device (for example, a control device 7A described below) configured to control the air pressure adjustment device and the movement mechanism, wherein the control device reduces the air pressure in the first and second chambers to a predetermined first air pressure lower than atmospheric pressure, then increases the air pressure in the second chamber to a second air pressure higher than the first air pressure and lower than atmospheric pressure in a state in which the bonding member and the bonding target member are brought close to each other, and then increases the air pressure in the first and second chambers to atmospheric pressure.

(3) In this case, it is preferable that the control device increases the air pressure in the second chamber to the second air pressure while maintaining the air pressure in the first chamber equal to or lower than the first air pressure in a state in which the bonding member and the bonding target member are brought close to each other.

(4) In this case, it is preferable that the control device increases the air pressure in the second chamber to the second air pressure, then establishes communication between the first chamber and the second chamber, and then increases the air pressure in the first and second chamber to atmospheric pressure.

(5) A bonding method according to the present invention is a bonding method for bonding a thin-membrane-shaped bonding member (for example, a film F described below) to a bonding target member (for example, a workpiece W described below), the method including: a placing step (for example, steps S1 to S3 of FIG. 4 or S11 of FIG. 7 described below) of placing the bonding member inside a box body (for example, a box body B or a big box 3A described below), demarcating a first chamber (for example, a lower vacuum chamber 32 or a big vacuum chamber 32A described below) and a second chamber (for example, an upper vacuum chamber 22 or a small vacuum chamber 22A described below) with the bonding member as a boundary inside the box body, and placing the bonding target member in the first chamber; a pressure reduction step (for example, step S4 of FIG. 4 or S12 of FIG. 7 described below) of reducing air pressure in the first and second chambers to a predetermined first air pressure lower than atmospheric pressure; a molding preparation step (for example, step S5 of FIG. 4 or S13 of FIG. 7 described below) of bringing the bonding member and the bonding target member close to each other; a primary molding step (for example, step S6 of FIG. 4 or S14 of FIG. 7 described below) of increasing the air pressure in the second chamber to a second air pressure higher than the first air pressure and lower than atmospheric pressure in a state in which the bonding member and the bonding target member are brought close to each other; and a secondary molding step (for example, step S7 of FIG. 4 or S15 of FIG. 7 described below) of increasing the air pressure in the first and second chambers to atmospheric pressure.

### Effects of the Invention

(1) The bonding apparatus according to the present invention includes a box body configured to grip a thin-membrane-shaped bonding member inside the box body; a first chamber and a second chamber demarcated by the bonding member inside the box body; an air pressure adjustment device configured to adjust an air pressure in the first and second chambers; a movement mechanism configured to move the bonding target member inside the first chamber; and a control device configured to control the air pressure adjustment device and the movement mechanism. In addition, the control device reduces the air pressure in the first and second chambers to a first air pressure lower than atmospheric pressure, then increases the air pressure in the second chamber to a second air pressure higher than the first air pressure and lower than atmospheric pressure in a state in which the bonding member and the bonding target member are brought close to each other. This creates a pressure difference between the first chamber and the second chamber, causing the bonding member to deform to follow the shape of the surface of the bonding target member. After increasing the air pressure in the second chamber to the second air pressure, the control device then increases the air pressure in the first and second chambers to atmospheric pressure, thereby bonding the bonding member to the bonding target member. According to the bonding apparatus of the present invention as described above, it is possible to closely bond the bonding member to follow the shape of the surface of the bonding target member by simply increasing the air pressure in the second chamber to the second air pressure in a state in which the bonding member and the bonding target member are in contact with each other, which eliminates the need for a manual packing task as in the conventional art. Moreover, according to the bonding apparatus of the present invention, after pressure has been reduced in the first and second chambers, the second chamber is increased to the second air pressure that is higher than the first air pressure and lower than atmospheric pressure, before the pressure in the first and second chambers is increased to atmospheric pressure. Therefore, compared to a case in which pressure in the second chamber is increased from a vacuum to atmospheric pressure as in the conventional art, the pressure difference between the first chamber and the second chamber can be made smaller, which may suppress deformation of the bonding target member when the air pressure in the second chamber is increased to the second air pressure, which in turn obviates the need for a jig to suppress deformation of the bonding target member.

(2) The bonding apparatus according to the present invention includes a small box body configured to grip an edge portion of a thin-membrane-shaped bonding member; a big box body having a first chamber configured to house the bonding target member and the small box body; an air pressure adjustment device configured to adjust an air pressure in the first chamber and an air pressure in a second chamber demarcated by the bonding member inside the small box body; a movement mechanism configured to move the small box body or the bonding target member; and a control device configured to control the air pressure adjustment device and the movement mechanism. In addition, the control device reduces the air pressure in the first and second chambers to a first air pressure lower than atmospheric pressure, then increases the air pressure in the second chamber to a second air pressure higher than the first air pressure and lower than atmospheric pressure in a state in which the bonding member and the bonding target member are brought close to each other. This creates a pressure difference between the first chamber and the second chamber, causing the bonding member to deform to follow the shape of the surface of the bonding target member. After increasing the air pressure in the second chamber to the second air pressure, the control device then increases the air pressure in the first and second chambers to atmospheric pressure, thereby bonding the bonding member to the bonding target member. According to the bonding apparatus of the present invention as described above, it is possible to closely bond the bonding member to follow the shape of the surface of the bonding target member by simply increasing the air pressure in the second chamber to the second air pressure in a state in which the bonding member and the bonding target member are in contact with each other, which eliminates the need for a manual packing task as in the conventional art. Moreover, according to the bonding apparatus of the present invention, after pressure has been reduced in the first and second chambers, the second chamber is increased to the second air pressure that is higher than the first air pressure and lower than atmospheric pressure, before the pressure in the first and second chambers is increased to atmospheric pressure. Therefore, compared to a case in which pressure in the second chamber is increased from a vacuum to atmospheric pressure as in the conventional art, the pressure difference between the first chamber and the second chamber can be made smaller, which may suppress deformation of the bonding target member when the air pressure in the second chamber is increased to the second air pressure, which in turn obviates the need for a jig to suppress deformation of the bonding target member.

(3) In the bonding apparatus of the present invention, the control device increases the air pressure in the second chamber to the second air pressure while maintaining the air pressure in the first chamber equal to or lower than the first air pressure in a state in which the bonding member and the bonding target member are brought close to each other. This creates a pressure difference between the first chamber and the second chamber demarcated by the bonding member, making it possible to closely bond the bonding member to follow the shape of the surface of the bonding target member.

(4) In the bonding apparatus of the present invention, the control device increases the air pressure in the second chamber to the second air pressure, then establishes communication between the first chamber and the second chamber, and then increases the air pressure in the first and second chamber to atmospheric pressure. This makes it possible to prevent the pressure difference between the first chamber and the second chamber from becoming too big while the pressure in the first and second chambers is increased from the first or second air pressure to atmospheric pressure, which makes it possible to prevent deformation of the bonding target member due to the pressure difference while the pressure in the first and second chambers is increased to atmospheric pressure.

(5) The bonding method according to the present invention includes a placing step of placing the bonding member inside a box body, demarcating a first chamber and a second chamber with the bonding member as a boundary inside the box body, and placing the bonding target member in the first chamber; a pressure reduction step of reducing air pressure in the first and second chambers to a predetermined first air pressure lower than atmospheric pressure; a molding preparation step of bringing the bonding member and the bonding target member close to each other; a primary molding step of increasing the air pressure in the second chamber to a second air pressure higher than the first air pressure and lower than atmospheric pressure in a state in which the bonding member and the bonding target member are brought close to each other; and a secondary molding step of increasing the air pressure in the first and second chambers to atmospheric pressure. According to the bonding method of the present invention, like the invention described in (1) above, the bonding member can be closely bonded to follow the shape of the surface of the bonding target member without performing a packing task as in the conventional art. Moreover, according to the bonding method of the present invention, like the invention described in (1) above, it is possible to suppress deformation of the bonding target member when the air pressure in the second chamber is increased to the second air pressure, which in turn obviates the need for a jig to suppress deformation of the bonding target member.

### BRIEF DESCRIPTION OF THE DRAWINGS

FIG. 1 shows a schematic view of a configuration of a bonding apparatus according to a first embodiment of the present invention;

FIG. 2 shows a schematic view of the configuration of the bonding apparatus;

FIG. 3 is a perspective view showing an upper gripping frame, a lower gripping frame, and a film;

FIG. 4 is a flowchart showing steps of a bonding method using the bonding apparatus;

FIG. 5A schematically shows an operation of the bonding apparatus in each step of the bonding method;

FIG. 5B schematically shows an operation of the bonding apparatus in each step of the bonding method;

FIG. 5C schematically shows an operation of the bonding apparatus in each step of the bonding method;

FIG. 5D schematically shows an operation of the bonding apparatus in each step of the bonding method;

FIG. 5E schematically shows an operation of the bonding apparatus in each step of the bonding method;

FIG. 5F schematically shows an operation of the bonding apparatus in each step of the bonding method;

FIG. 5G schematically shows an operation of the bonding apparatus in each step of the bonding method;

FIG. 5H schematically shows an operation of the bonding apparatus in each step of the bonding method;

FIG. 6 shows a schematic view of a configuration of a bonding apparatus according to a second embodiment of the present invention;

FIG. 7 is a flowchart showing steps of a bonding method using the bonding apparatus;

FIG. 8A schematically shows an operation of the bonding apparatus in each step of the bonding method;

FIG. 8B schematically shows an operation of the bonding apparatus in each step of the bonding method;

FIG. 8C schematically shows an operation of the bonding apparatus in each step of the bonding method; and

FIG. 8D schematically shows an operation of the bonding apparatus in each step of the bonding method.

### PREFERRED MODE FOR CARRYING OUT THE INVENTION

### First Embodiment

Below, a configuration of a bonding apparatus 1 according to a first embodiment of the present invention is described with reference to the drawings.

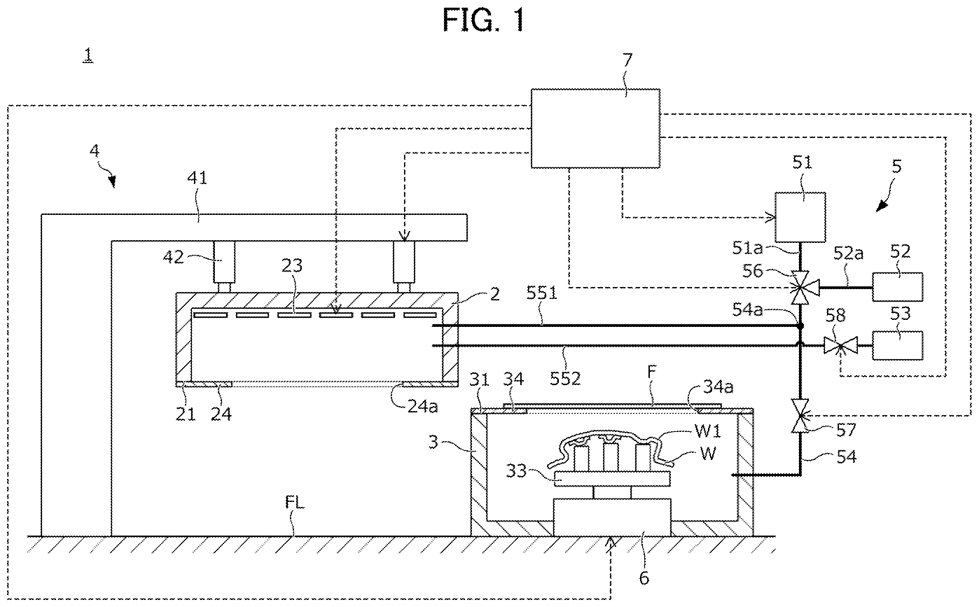

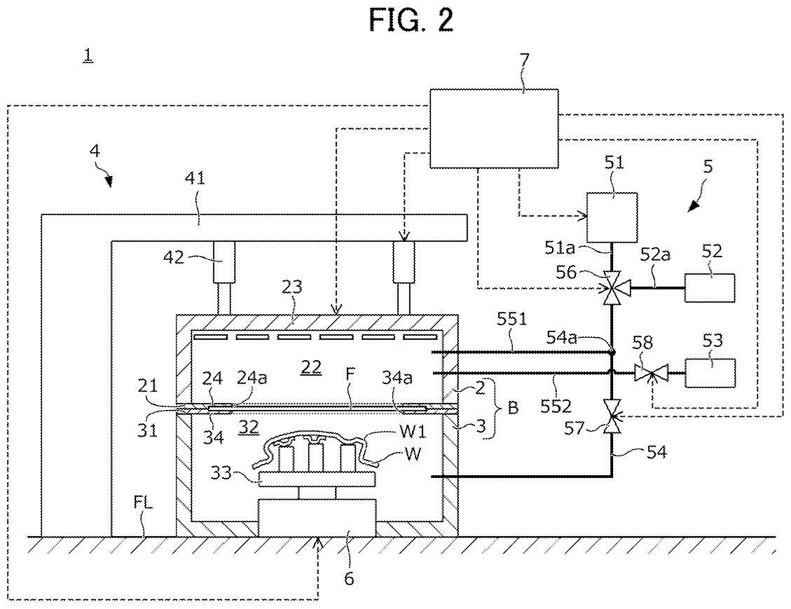

FIG. 1 and FIG. 2 are schematic views of a configuration of the bonding apparatus 1 according to the present embodiment. The bonding apparatus 1 bonds a film F, which is a thin-membrane-shaped bonding member, to a surface W1 of a workpiece W, which is a bonding target member. The bonding apparatus 1 includes an upper box 2 supported by a support device 4 at a position separated from a work floor FL, a lower box 3 that is freely movable on the work floor FL, an air pressure adjustment device 5 that adjusts an air pressure in the upper box 2 and the lower box 3, a movement mechanism 6 that moves a stage 33 provided inside the lower box 3, and a control device 7 that controls the air pressure adjustment device 5 and movement mechanism 6, etc.

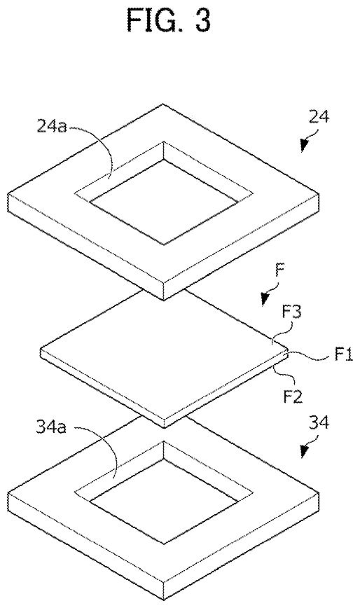

The workpiece W is a vehicle part such as an outer side panel, door, bonnet, etc. of a vehicle. The film F is a thin membrane that is rectangular as seen in a plan view, and is stretchable along the direction in which it extends. The film F has, for example, a three-layer structure in which an adhesive layer F2 and a clear layer F3 are formed on respective sides of a substrate F1 (see, for example, FIG. 3 described below). In the substrate F1, a material such as, for example, polyvinyl chloride, AES, urethane, olefin, or polyester is used. In the adhesive layer F2, a materiel such as, for example, olefin, urethane, or an acrylic is used. In the clear layer F3, a material such as, for example, an acrylic, urethane, polyvinyl chloride, or polyester is used. The bonding apparatus 1 bonds the adhesive layer F2 to a surface W1 of the workpiece W, so that the clear layer F3 of the film F as described above constitutes the design surface.

The upper box 2 is box-shaped, and there is a rectangular upper opening 21 formed on the face on the lower side in the vertical direction. Heaters 23 are provided at positions of the interior of the upper box 2 facing the upper opening 21. The heaters 23 emit heat based on an instruction from the control device 7 to heat the film F.

The support device 4 includes a support frame 41 erected on the work floor FL, and a plurality of cylinders 42 that connect the support frame 41 and the upper box 2. The cylinders 42 extend and contract in the vertical direction based on an instruction from the control device 7, which raises and lowers the upper box 2 in the vertical direction.

The lower box 3 is box-shaped, and there is a rectangular lower opening 31 formed on the face on the upper side in the vertical direction of approximately the same shape as the upper opening 21 of the upper box 2. The interior of the lower box 3 is provided with a stage 33. On this stage 33, the workpiece W is placed with its surface W1 facing up in the vertical direction.

Based on an instruction from the control device 7, the movement mechanism 6 raises or lowers the stage 33 provided in the interior of the lower box 3 and the workpiece W placed on the stage 33 in the vertical direction.

In addition, the upper opening 21 of the upper box 2 and the lower opening 31 of the lower box 3 are respectively provided with an upper gripping frame 24 and a lower gripping frame 34, which are shaped as rectangular frames. As shown in FIG. 3, in these gripping frames 24, 34, there are formed windows 24a, 34a, which are openings that are slightly smaller than the film F as seen in a plan view. Therefore, as shown in FIG. 3, by bringing these gripping frames 24, 34 close to each other with the film F sandwiched therebetween, the edge portions of the film F are held by the gripping frames 24, 34. Gripping the edge portions of the film F with the gripping frames 24, 34 makes it possible to stretch the film F inside the windows 24a, 34a.

The work floor FL is provided with a guide rail not shown here, and the lower box 3 is movable along this guide rail. This allows the control device 7 to move the lower box 3 into a position that faces the upper box 2 in the vertical direction (see FIG. 2), or to move the lower box 3 to a position away from the position below the upper box 2 in the vertical direction (see FIG. 1).

It should be noted that although the present embodiment describes a case in which the position of the upper box 2 relative to the work floor FL is fixed and the lower box 3 is movable on the work floor FL in order to enable placing of the workpiece W in the lower box 3, the present invention is not so limited. For example, the position of the lower box 3 relative to the work floor FL may be fixed, and the upper box 2 may be made movable over the work floor FL. In addition, so long as the workpiece W can be placed inside the lower box 3, the positions of both the lower box 3 and the upper box 2 relative to the work floor FL may be fixed.

As stated above, the lower opening 31 of the lower box 3 is of approximately the same shape as the upper opening 21 of the upper box 2. Further, as stated above, by bringing the gripping frames 24, 34 close to each other, the edge portions of the film F are held by the gripping frames 24, 34. Therefore, by moving the lower box 3 to a position that faces the upper box 2 and lowering the upper box 2 by means of the cylinders 42 to bring the upper gripping frame 24 and the lower gripping frame 34 into close contact, the upper box 2, lower box 3, upper gripping frame 24, and lower gripping frame 34 form one box body B that grips the film F therein, as shown in FIG. 2.

Further, as stated above, gripping the edge portions of the film F with the gripping frames 24, 34 makes it possible to stretch the film F inside the windows 24a, 34a. Therefore, when the upper box 2 is lowered as shown in FIG. 2, the film F demarcates the interior of the box body B into an upper vacuum chamber 22 and a lower vacuum chamber 32. The upper vacuum chamber 22 is a highly airtight closed space formed in the interior of the upper box 2 with the film F as a boundary, and the lower vacuum chamber 32 is a highly airtight closed space formed in the interior of the lower box 3 with the film F as a boundary.

Further, then the lower box 3 is moved to a position away from the position below the upper box 2 in the vertical direction, the interior of the lower box 3 is exposed, as shown in FIG. 1. This allows a worker to place a new workpiece W that has yet to have a film F applied thereto on the stage 33 in the lower box 3, and to remove the workpiece W from the stage 33 after the film F has been applied.

The air pressure adjustment device 5 includes a vacuum pump 51, a first tank 52, a second tank 53, a lower pipe 54, a first upper pipe 551, a second upper pipe 552, a three-way valve 56, a first cutoff valve 57, and a second cutoff valve 58.

The lower pipe 54 communicates with the three-way valve 56, and the interior of the lower box 3. The first upper pipe 551 communicates with the lower pipe 54 and the interior of the upper box 2. The first cutoff valve 57 is provided to the lower pipe 54 closer to the three-way valve 56 side than a connection part 54a of the first upper pipe 551, and is opened and closed according to an instruction from the control device 7. opening the first cutoff valve 57 establishes communication between the upper vacuum chamber 22 and the lower vacuum chamber 32. Therefore, opening the first cutoff valve 57 allows for equalization of the air pressure in the upper vacuum chamber 22 and the air pressure in the lower vacuum chamber 32. Closing the first cutoff valve 57 cuts off the upper vacuum chamber 22 and the lower vacuum chamber 32 from each other. Accordingly, closing the first cutoff valve 57 allows for the creation of a pressure difference between the interiors of the upper vacuum chamber 22 and the lower vacuum chamber 32.

The vacuum pump 51 and the three-way valve 56 are connected via a vacuum pipe 51a. In addition, the first tank 52 and the three-way valve 56 are connected via an atmosphere release pipe 52a. In accordance with an instruction from the control device 7, the three-way valve 56 connects the lower pipe 54 and the vacuum pipe 51a, or the lower pipe 54 and the atmosphere release pipe 52a.

Connecting the lower pipe 54 and the vacuum pipe 51a by means of the three-way valve 56 establishes communication between the vacuum pump 51 and the interiors of the upper box 2 and the lower box 3. The vacuum pump 51 is turned on in accordance with an instruction from the control device 7, and discharges air sucked from the vacuum pipe 51a into the atmosphere to reduce air pressure in the interiors of the upper vacuum chamber 22 and the lower vacuum chamber 32.

Connecting the lower pipe 54 and the atmosphere release pipe 52a by means of the three-way valve 56 establishes communication between the first tank 52 and the interiors of the upper box 2 and the lower box 3. Air pressure in the first tank 52 is set to be equal to or higher than atmospheric pressure. Therefore, connecting the lower pipe 54 and the atmosphere release pipe 52a by means of the three-way valve 56 allows for increasing the air pressure in the upper vacuum chamber 22 and the lower vacuum chamber 32 to equal to or higher than atmospheric pressure. It is preferable that the air pressure in the upper vacuum chamber 22 and the lower vacuum chamber 32 be increased as quickly as possible. It is therefore preferable that the air pressure in the first tank 52 be maintained at a higher pressure than atmospheric pressure by a pressurizing pump not shown here.

The second upper pipe 552 communicates with the second tank 53 and the interior of the upper box 2. The second cutoff valve 58 is provided to the second upper pipe 552, and is opened and closed in accordance with an instruction from the control device 7. Air pressure in the second tank 53 is set to be equal to or higher than a second air pressure described later and lower than atmospheric pressure. Therefore, when the second cutoff valve 58 is opened in a state in which the air pressure in the upper vacuum chamber 22 is lower than the second air pressure, communication is established between the upper vacuum chamber 22 and the second tank 53, allowing for an increase of the air pressure in the upper vacuum chamber 22 to equal to or higher than the second air pressure. Further, closing the second cutoff valve 58 cuts off the upper vacuum chamber 22 and the second tank 53 from each other. It is preferable that the air pressure in the upper vacuum chamber 22 be increased as quickly as possible. It is therefore preferable that the second tank 53 and the vacuum pump 51 be connected by a pipe not shown here, and that the air pressure in the second tank 53 be maintained by the vacuum pump 51 in a state higher than the second air pressure and lower than atmospheric pressure.

The air pressure adjustment device 5 drives the vacuum pump 51, three-way valve 56, first cutoff valve 57, and second cutoff valve 58 in accordance with an instruction from the control device 7 to adjust the air pressure in the upper vacuum chamber 22 and the lower vacuum chamber 32.

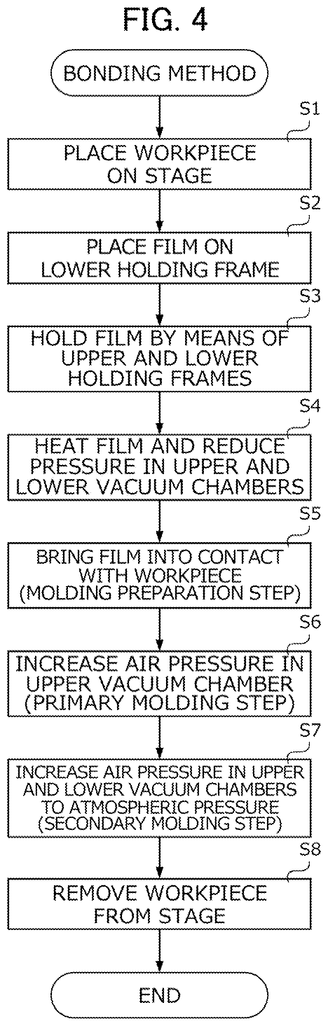

The control device 7 is a computer that controls the heaters 23, cylinders 42, air pressure adjustment device 5, and movement mechanism 6 according to the steps shown in FIG. 4.

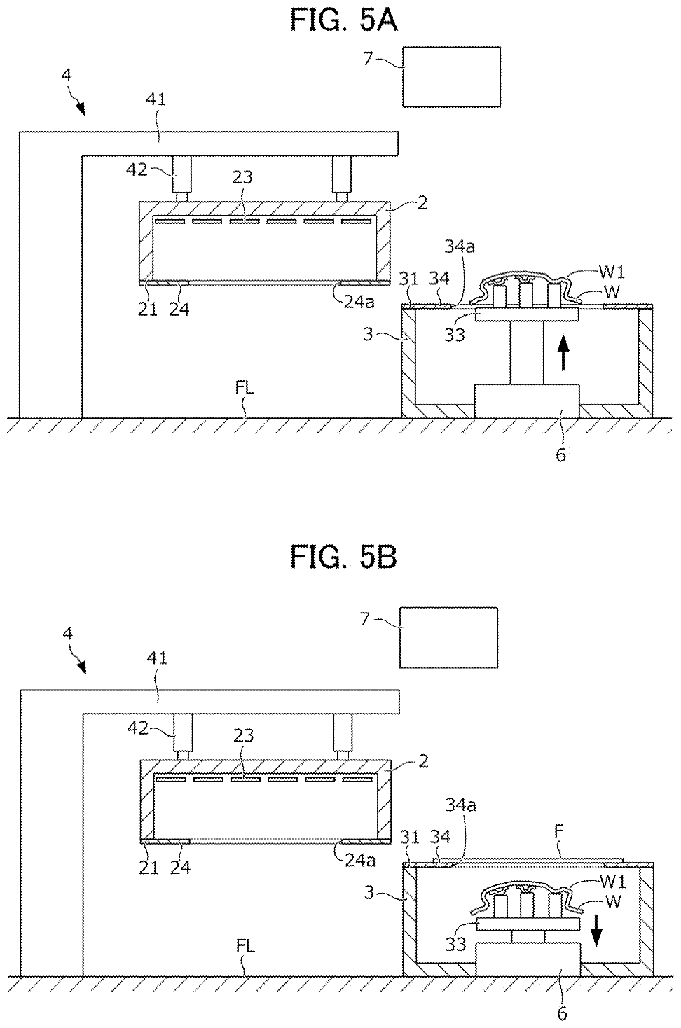

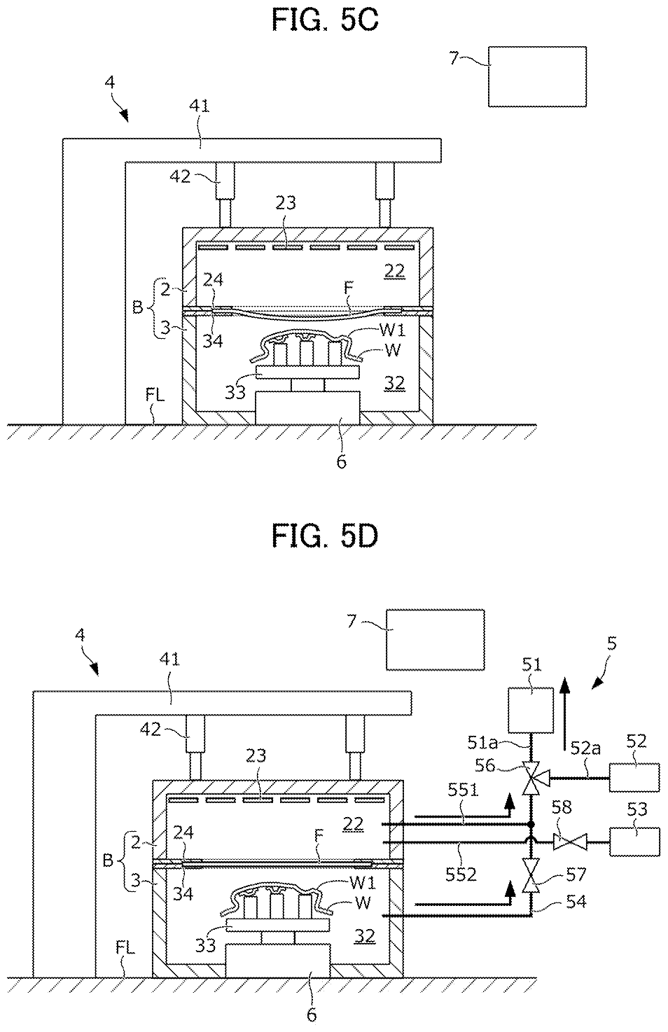

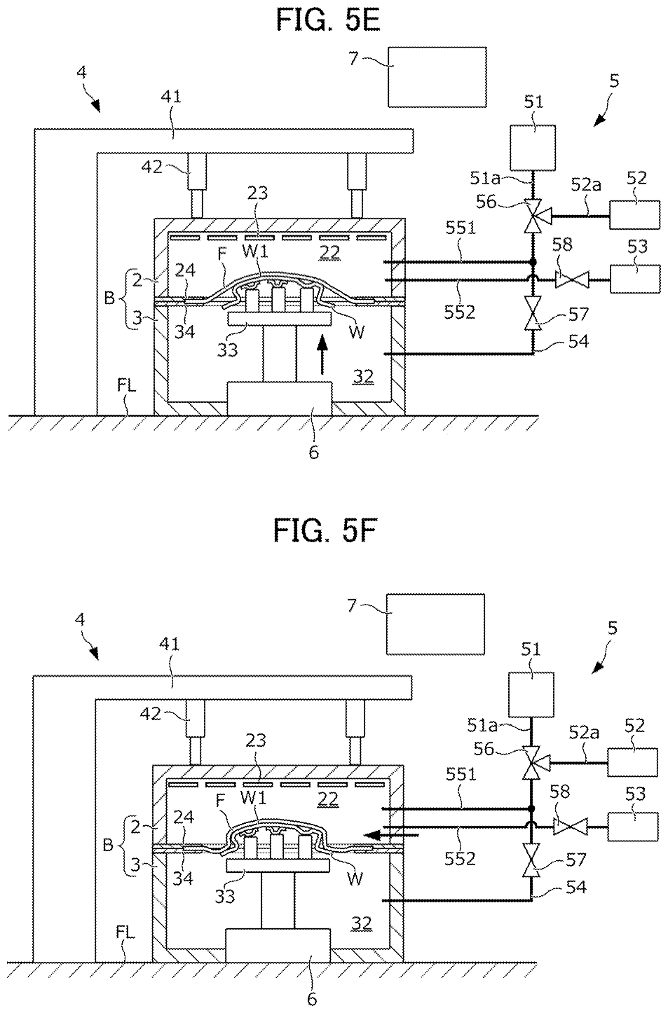

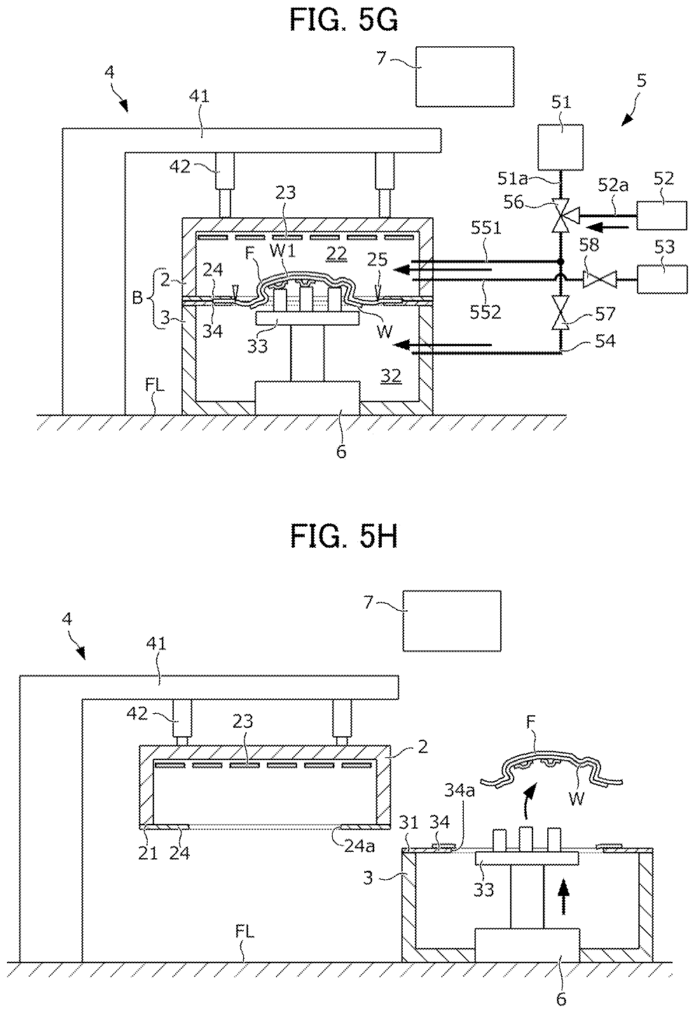

FIG. 4 is a flowchart showing the steps of a bonding method for bonding the film F to the workpiece W by using the bonding apparatus 1 as described above. FIGS. 5A to 5H schematically show operations of the bonding apparatus 1 at each step of the bonding method. It should be noted that FIGS. 5A to 5H omit illustrations of device configurations not used in these steps.

First, at S1, a worker places a new workpiece W on the stage 33. More specifically, at S1, the control device 7 moves the lower box 3 to a position away from a position below the upper box 2 in the vertical direction, and raises the stage 33 to a height close to the lower opening 31 (see FIG. 5A). After that, the worker places a prepared workpiece W on the stage 33.

At S2, the worker places a new film F on the lower gripping frame 34. More specifically, at S2, the control device 7 lowers the stage 33 to retract the workpiece W placed on the stage 33 into the interior of the lower box 3 (see FIG. 5B). After that, the worker places a prepared film F on the lower gripping frame 34 so as to cover the window 34a.

Next, at S3, the control device 7 grips the film F by means of the upper gripping frame 24 and the lower gripping frame 34. More specifically, at S3, the control device 7 moves the lower box 3 to a position that faces the upper box 2 in the vertical direction, and lowers the upper box 2 to bring the upper gripping frame 24 and the lower gripping frame 34 into close contact with each other (see FIG. 5C). Thus, as shown in FIG. 5C, the interior of the box body B constituted by the combination of the upper box 2 and the lower box 3 is demarcated into the upper vacuum chamber 22 and the lower vacuum chamber 32, and the workpiece W is placed inside the lower vacuum chamber 32. It should be noted that, as shown in FIG. 5C, since the air pressure in the upper vacuum chamber 22 and the lower vacuum chamber 32 at this point are both equal to atmospheric pressure, the film F sags slightly due to its own weight, and is thus slightly convex in the downward vertical direction.

Next, at S4, the control device 7 heats the film F and reduces air pressure in the upper vacuum chamber 22 and the lower vacuum chamber 32. More specifically, at S4, the control device 7 heats the film F to a predetermined set temperature by turning the heaters 23 on for a predetermined length of time. Here, the set temperature of the film F is set within a range of, for example, 70 to 200° C., depending on the material of the film F. In addition, the control device 7 establishes communication between the upper vacuum chamber 22 and the lower vacuum chamber 32 by opening the cutoff valve 57, connects the lower pipe 54 and the vacuum pump 51 by means of the three-way valve 56, and further turns on the vacuum pump 51 for a predetermined length of time, in order to, as shown in FIG. 5D, reduce air pressure in the interiors of the upper vacuum chamber 22 and the lower vacuum chamber 32 to equal to or lower than a predetermined first air pressure. Here, the first air pressure is set to be lower than atmospheric pressure, within a range of, for example, 0 to 0.2 kPa.

A film F as described above will sag slightly due to its own weight. Therefore, at S4, the control device 7 may provide a slight pressure difference (for example, 0 to 0.1 kPA) between the upper vacuum chamber 22 and the lower vacuum chamber 32, so that the air pressure in the interior of the upper vacuum chamber 22 becomes slightly lower than the air pressure in the interior of the lower vacuum chamber 32, thereby eliminating sagging of the film F after the pressure reduction. Such a pressure difference can be realized by turning the vacuum pump 53 on while opening the first cutoff valve 57 to reduce air pressure in the interiors of the two vacuum chambers 22, 32, and then closing the first cutoff valve 57 and continuing air pressure reduction in only the upper vacuum chamber 22 for a brief time.

Next, at S5, the control device 7 executes a molding preparation step of bringing the film F and the workpiece W close to each other, and more preferably bringing the film F and the workpiece W into contact with each other. More specifically, the control device 7 uses the movement mechanism 6 to raise the stage 33 so that at least part of the workpiece W extends into the interior of the upper box 2. This brings the film F and the workpiece W close to each other. However, in this molding preparation step, it is preferable that the film F and the workpiece W are brought close enough to each other to make at least part of a surface W1 of the workpiece W contact the adhesive layer F2 of the film F, and make the film F bulge convexly upward in the vertical direction, as shown in FIG. 5E.

Next, at S6, the control device 7 executes a primary molding step of raising the interior of the upper vacuum chamber 22 in a state in which the film F and the workpiece W are in contact with each other. More specifically, in a state in which the film F and the workpiece W are in contact with each other, the control device 7 opens the second cutoff valve 58 to establish communication between the upper vacuum chamber 22 and the second tank 53 for a predetermined length of time, in order to increase the air pressure in the interior of the upper vacuum chamber 22 to a predetermined second air pressure. Here, the second air pressure is set to be higher than the above first air pressure and lower than atmospheric pressure.

In this primary molding step, the control device 7 maintains the air pressure in the interior of the lower vacuum chamber 32 equal to or lower than the first air pressure by opening the second cutoff valve 58 for a predetermined length of time with the first cutoff valve 57 closed. This allows for the formation of a pressure difference between the upper vacuum chamber 22 and the lower vacuum chamber 32, where the upper vacuum chamber 22 has a higher pressure and the lower vacuum chamber 32 has a lower pressure. Because of this, a pressure of a magnitude corresponding to the pressure difference will act on the film F from the upper vacuum chamber 22 toward the lower vacuum chamber 32, which makes it possible to deform the film F to follow the shape of the surface W1 of the workpiece W (see FIG. 5F). It should be noted that the second air pressure is set to be of a magnitude that does not cause the workpiece W to be deformed by the pressure acting on the workpiece W through the film F, for example, within a range of 0.01 to 10 kPa. In other words, the second air pressure is set so that the pressure difference between the upper vacuum chamber 22 and the lower vacuum chamber 32 that occurs in the primary molding step stays within a range of, for example, 0 to 10 kPa.

Next, at S7, the control device 7 executes a secondary molding step of raising a pressure in the interiors of the upper vacuum chamber 22 and the lower vacuum chamber 32 to atmospheric pressure. More specifically, the control device 7 opens the first cutoff valve 57 and further connects the lower pipe 54 and the atmosphere release pipe 52a by means of the three-way valve 56 to establish communication of the upper vacuum chamber 22 and the lower vacuum chamber 32 with the first tank 52, raising the air pressure in the interiors of the vacuum chambers 22, 32 to atmospheric pressure. This bonds the film F to the surface W1 of the workpiece W. In this secondary molding step, when the air pressure in the interiors of the vacuum chambers 22, 32 is increased to atmospheric pressure, it is preferably increased to atmospheric pressure in as short a time as possible (for example, within three seconds) so that the pressure difference between the vacuum chambers 22, 32 is maintained equal to or lower than the pressure difference formed in the primary molding step of S6.

Further, in this secondary molding step, in order to maintain the pressure difference between the vacuum chambers 22, 32 equal to or lower than the pressure difference formed in the primary molding step of S6 while the air pressure in the interiors of the vacuum chambers 22, 32 is increased to atmospheric pressure, it is preferable that the edge portions of the film F are cut off by a cutter 25 provided in the interior of the upper box 2, and that communication is established between the upper vacuum chamber 22 and the lower vacuum chamber 32 before the interiors of the vacuum chambers 22, 32 are exposed to the atmosphere (see FIG. 5G). This makes it possible to prevent the pressure difference between the upper vacuum chamber 22 and the lower vacuum chamber 32 from becoming too big while the pressure in the upper vacuum chamber 22 and the lower vacuum chamber 32 is increased to atmospheric pressure, which makes it possible to prevent deformation of the workpiece W due to the pressure difference while the pressure in the upper vacuum chamber 22 and the lower vacuum chamber 32 is increased to atmospheric pressure.

Next, at S8, the worker removes the workpiece W with the film F bonded thereto from the lower box 3. More specifically, at S8, the control device 7 raises the upper box 2 and moves the lower box 3 to a position away from below the upper box 2, and then raises the stage 33. After that, the worker removes the workpiece W placed on the stage 33 from the lower box 3.

According to the bonding method according to the present embodiment as described above, it is possible to closely bond the film F to follow the shape of the surface W1 of the workpiece W by simply increasing the air pressure in the upper vacuum chamber 22 to the second air pressure in a state in which the film F and the workpiece W are in contact with each other, which eliminates the need for a manual packing task as in the conventional art. Further, according to the bonding method according to the present embodiment, after pressure has been reduced in the upper vacuum chamber 22 and the lower vacuum chamber 32, the upper vacuum chamber 22 is increased to the second air pressure that is higher than the first air pressure and lower than atmospheric pressure, before the pressure in the chambers 22, 32 is increased to atmospheric pressure. Therefore, compared to a case in which pressure in the upper vacuum chamber 22 is immediately increased from a vacuum to atmospheric pressure as in the conventional art, the pressure difference between the lower vacuum chamber 32 and the upper vacuum chamber 22 can be made smaller, which may suppress deformation of the workpiece W when the air pressure in the upper vacuum chamber 22 is increased to the second air pressure, which in turn obviates the need for a jig to suppress deformation of the workpiece W.

### Second Embodiment

Below, a configuration of a bonding apparatus 1A according to a second embodiment of the present invention is described with reference to the drawings. It should be noted that in the below description of the bonding apparatus 1A, the same configurations as in the bonding apparatus 1 according to the first embodiment are given the same reference numerals, and detailed description thereof is omitted.

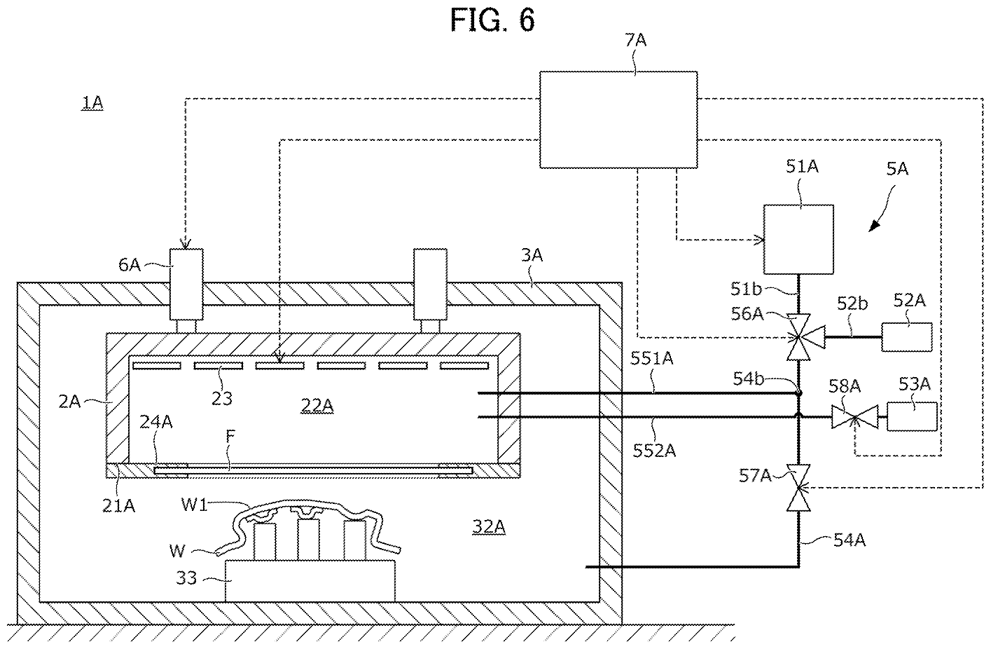

FIG. 6 shows a schematic view of the configuration of the bonding apparatus 1A according to the present embodiment. The bonding apparatus 1A includes a small box 2A that grips edge portions of a film F, a big box 3A including a big vacuum chamber 32A which is a space that houses a workpiece W and the small box 2A, an air pressure adjustment device 5A that adjusts an air pressure in the small box 2A and the big box 3A, a movement mechanism 6A that moves the small box 2A within the big vacuum chamber 32A, and a control device 7A that controls the air pressure adjustment device 5A and movement mechanism 6A, etc.

The small box 2A is box-shaped, and there is a rectangular opening 21A formed on the face on the lower side in the vertical direction. Heaters 23 for heating the film F are provided at positions of the interior of the small box 2A facing the opening 21A. In addition, the opening 21A of the small box 2A is provided with a rectangular frame-shaped film gripping frame 24A for gripping the edge portions of the film F. Thus, the interior of the small box 2A is demarcated into a small vacuum chamber 22A with the film F as a boundary.

The big box 3A is box-shaped, and houses the small box 2A and the workpiece W. The interior of the big box 3A is provided with a stage 33. On this stage 33, the workpiece W is placed with its surface W1 facing up in the vertical direction.

Based on an instruction from the control device 7A, the movement mechanism 6A raises or lowers the small box 2A provided in the interior of the big vacuum chamber 32A of the big box 3A in the vertical direction to move the film F held by the small box 2A away from or closer to the workpiece W.

The air pressure adjustment device 5A includes a vacuum pump 51A, a first tank 52A, a second tank 53A, a big box pipe 54A, a first small box pipe 551A, a second small box pipe 552A, a three-way valve 56A, a first cutoff valve 57A, and a second cutoff valve 58A.

The big box pipe 54A communicates with the three-way valve 56A, and the interior of the big box 3A. The first small box pipe 551A communicates with the big box pipe 54A and the interior of the small box 2A. The first cutoff valve 57A is provided to the big box pipe 54A closer to the three-way valve 56A side than a connection part 54b of the first small box pipe 551A, and is opened and closed according to an instruction from the control device 7A. Opening the first cutoff valve 57A establishes communication between the small vacuum chamber 22A and the big vacuum chamber 32A. Therefore, opening the first cutoff valve 57A allows for equalization of the air pressure in the small vacuum chamber 22A and the air pressure in the big vacuum chamber 32A. Closing the first cutoff valve 57A cuts off the small vacuum chamber 22A and the big vacuum chamber 32A from each other. Accordingly, closing the first cutoff valve 57A allows for the creation of a pressure difference between the interiors of the small vacuum chamber 22A and the big vacuum chamber 32A.

The vacuum pump 51A and the three-way valve 56A are connected via a vacuum pipe 51b. In addition, the first tank 52A and the three-way valve 56A are connected via an atmosphere release pipe 52b. In accordance with an instruction from the control device 7A, the three-way valve 56A connects the big box pipe 54A and the vacuum pipe 51b, or the big box pipe 54A and the atmosphere release pipe 52b.

Connecting the big box pipe 54A and the vacuum pipe 51b by means of the three-way valve 56A establishes communication between the vacuum pump 51A and the interiors of the small box 2A and the big box 3A. The vacuum pump 51A is turned on in accordance with an instruction from the control device 7A, and discharges air sucked from the vacuum pipe 51b into the atmosphere to reduce air pressure in the interiors of the small vacuum chamber 22A and the big vacuum chamber 32A.

Connecting the big box pipe 54A and the atmosphere release pipe 52b by means of the three-way valve 56A establishes communication between the first tank 52A and the interiors of the small box 2A and the big box 3A. Air pressure in the first tank 52A is set to be equal to or higher than atmospheric pressure. Therefore, connecting the big box pipe 54A and the atmosphere release pipe 52b by means of the three-way valve 56A allows for increasing the air pressure in the small vacuum chamber 22A and the big vacuum chamber 32A to equal to or higher than atmospheric pressure. It is preferable that the air pressure in the small vacuum chamber 22A and the big vacuum chamber 32A be increased as quickly as possible. It is therefore preferable that the air pressure in the first tank 52A be maintained at a higher pressure than atmospheric pressure by a pressurizing pump not shown here.

The second small box pipe 552A communicates with the second tank 53A and the interior of the small box 2A. The second cutoff valve 58A is provided to the second small box pipe 552A, and is opened and closed in accordance with an instruction from the control device 7A. Air pressure in the second tank 53A is set to be equal to or higher than a second air pressure described later and lower than atmospheric pressure. Therefore, when the second cutoff valve 58A is opened in a state in which the air pressure in the small vacuum chamber 22A is lower than the second air pressure, communication is established between the small vacuum chamber 22A and the second tank 53A, allowing for an increase of the air pressure in the small vacuum chamber 22A to equal to or higher than the second air pressure. Further, closing the second cutoff valve 58A cuts off the small vacuum chamber 22A and the second tank 53A from each other. It is preferable that the air pressure in the small vacuum chamber 22A be increased as quickly as possible. It is therefore preferable that the second tank 53A and the vacuum pump 51A be connected by a pipe not shown here, and that the air pressure in the second tank 53A be maintained by the vacuum pump 51A in a state higher than the second air pressure and lower than atmospheric pressure.

The air pressure adjustment device 5A drives the vacuum pump 51A, three-way valve 56A, first cutoff valve 57A, and second cutoff valve 58A in accordance with an instruction from the control device 7A to adjust the air pressure in the small vacuum chamber 22A and the big vacuum chamber 32A.

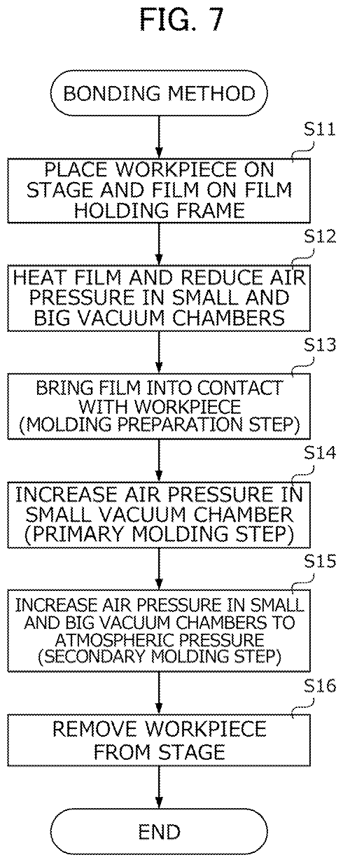

The control device 7A is a computer that controls the heaters 23, air pressure adjustment device 5A, and movement mechanism 6A according to the steps shown in FIG. 7.

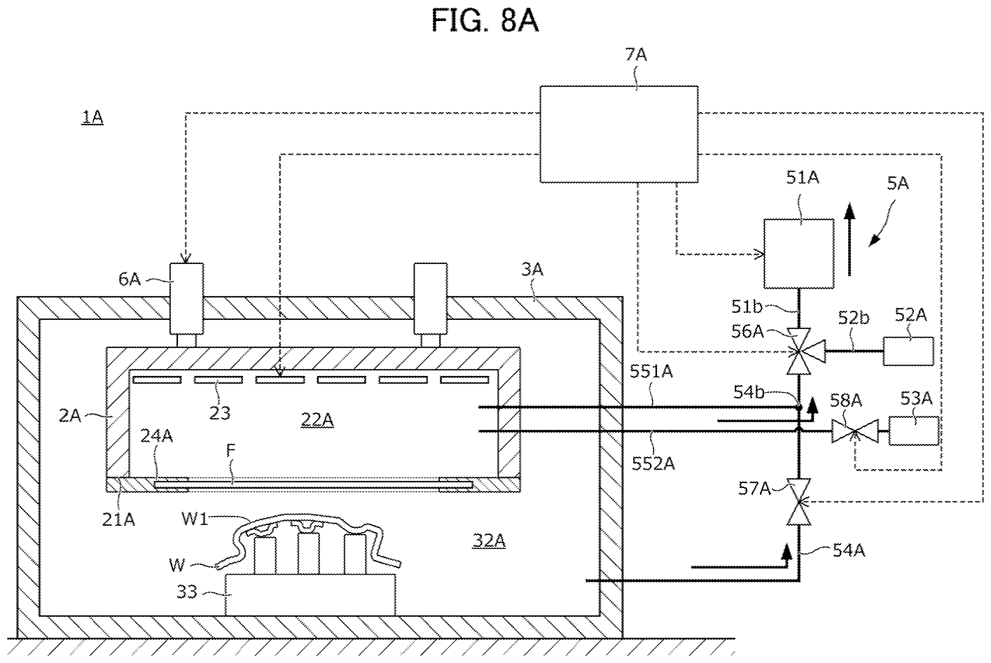

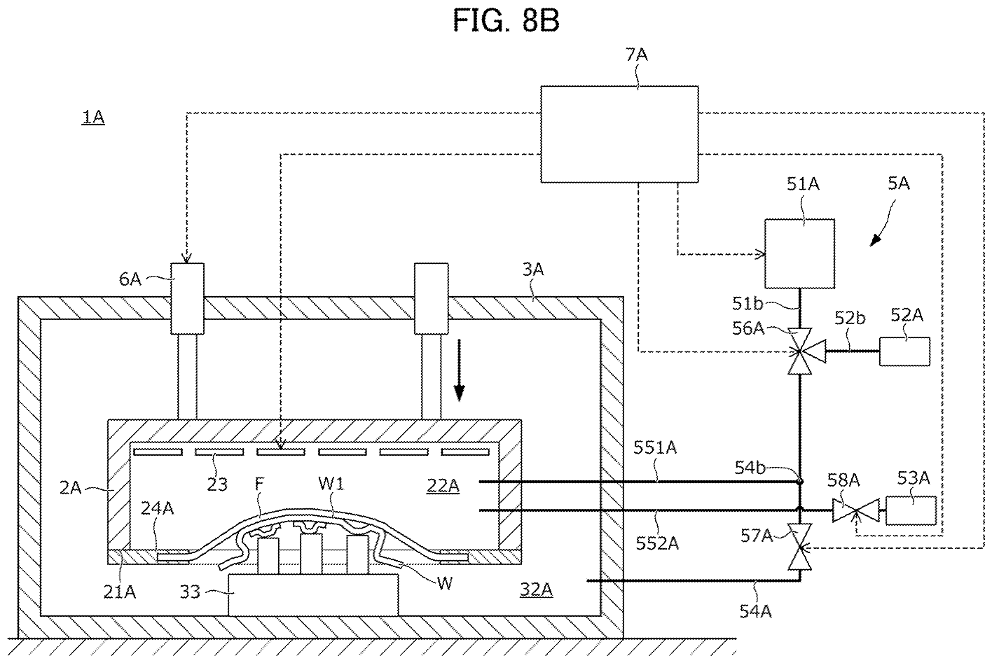

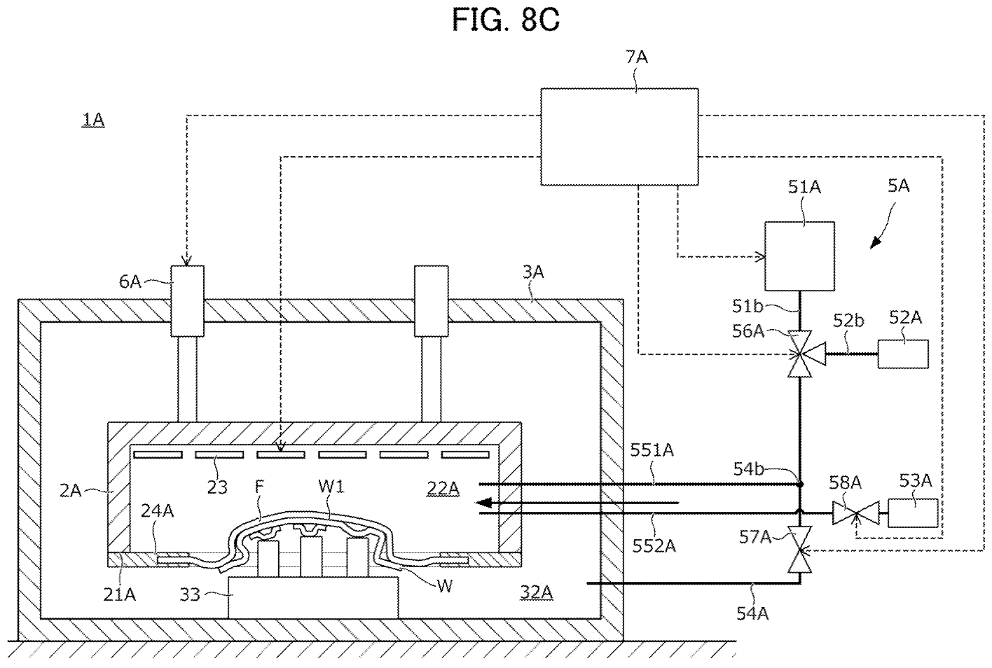

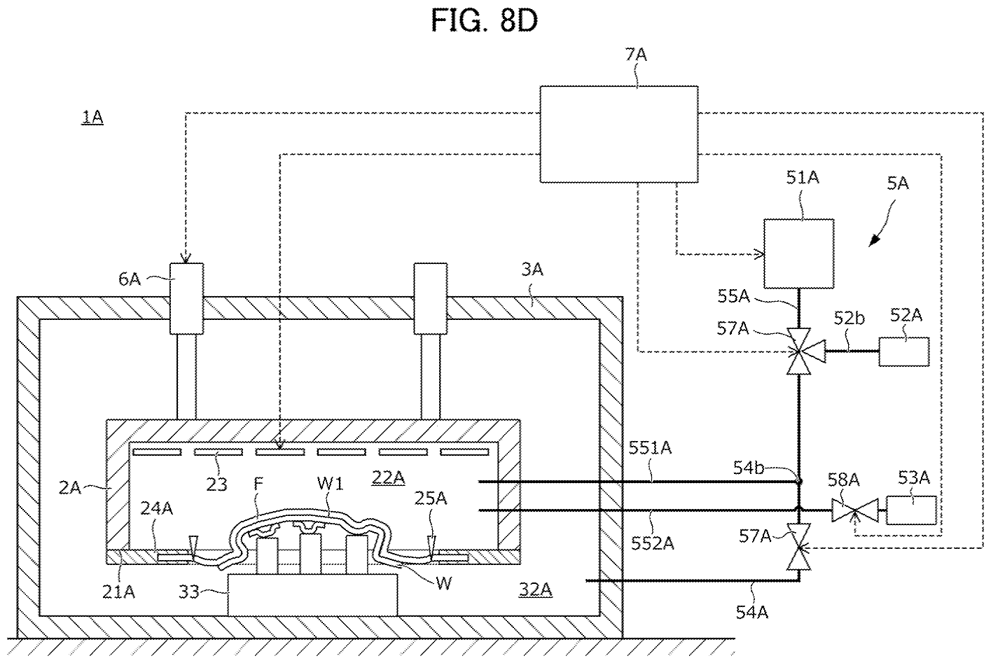

FIG. 7 is a flowchart showing the steps of a bonding method for bonding the film F to the workpiece W by using the bonding apparatus 1A as described above. FIGS. 8A to 8D schematically show operations of the bonding apparatus 1A at each step of the bonding method.

First, at S11, a worker places a new workpiece W on the stage 33, and places a new film F in the film gripping frame 24A of the small box 2A.

Next, at S12, the control device 7A heats the film F and reduces pressure in the interiors of the small vacuum chamber 22A and the big vacuum chamber 32A. More specifically, at S12, the control device 7A heats the film F to a predetermined set temperature by turning the heaters 23 on for a predetermined length of time. Here, the set temperature of the film F is set within a range of, for example, 70 to 200° C., depending on the material of the film F. In addition, the control device 7A establishes communication between the small vacuum chamber 22A and the big vacuum chamber 32A by opening the cutoff valve 57A, connects the big box pipe 54A and the vacuum pump 51A by means of the three-way valve 56A, and further turns on the vacuum pump 51A for a predetermined length of time, in order to, as shown in FIG. 8A, reduce air pressure in the interiors of the small vacuum chamber 22A and the big vacuum chamber 32A to equal to or lower than a predetermined first air pressure. Here, the first air pressure is set to be lower than atmospheric pressure, within a range of, for example, 0 to 0.2 kPa.

Moreover, as described in the first embodiment, the film F will sag slightly due to its own weight. Therefore, at S12, a slight pressure difference (for example, 0 to 0.1 kPA) between the small vacuum chamber 22A and the big vacuum chamber 32A may be provided by the same procedure as in S4 of FIG. 4, so that sagging of the film F after the pressure reduction is eliminated.

Next, at S13, the control device 7A executes a molding preparation step of bringing the film F and the workpiece W close to each other, and more preferably bringing the film F and the workpiece W into contact with each other. More specifically, the control device 7A uses the movement mechanism 6A to lower the small box 2A toward the workpiece W. This brings the film F and the workpiece W close to each other. However, in this molding preparation step, it is preferable that the film F and the workpiece W are brought close enough to each other to make at least part of a surface W1 of the workpiece w contact the adhesive layer F2 of the film F, and make the film F bulge convexly upward in the vertical direction, as shown in FIG. 8B.

Next, at S14, the control device 7A executes a primary molding step of raising the interior of the small vacuum chamber 22A in a state in which the film F and the workpiece W are in contact with each other. More specifically, in a state in which the film F and the workpiece W are in contact with each other, the control device 7A opens the second cutoff valve 58A to introduce outside air into the interior of the small vacuum chamber 22A, thereby increasing the air pressure in the interior of the small vacuum chamber 22A to a predetermined second air pressure. Here, the second air pressure is set to be higher than the above first air pressure arid lower than atmospheric pressure.

In this primary molding step, the control device 7A maintains the air pressure in the interior of the big vacuum chamber 32A equal to or lower than the first air pressure by opening the second cutoff valve 58A for a predetermined length of time with the first, cutoff valve 57A closed. This allows for the formation of a pressure difference between the small vacuum chamber 22A and the big vacuum chamber 32A, where the small vacuum chamber 22A has a higher pressure and the big vacuum chamber 32A has a lower pressure. Because of this, a pressure of a magnitude corresponding to the pressure difference will act on the film F from the small vacuum chamber 22A toward the big vacuum chamber 32A, which makes it possible to deform the film F to follow the shape of the surface W1 of the workpiece W (see FIG. 8C). It should be noted that the second air pressure is set to be of a magnitude that does not cause the workpiece W to be deformed by the pressure acting on the workpiece W through the film F, for example, within a range of 0.01 to 10 kPa. In other words, the second air pressure is set so that the pressure difference between the small vacuum chamber 22A and the big vacuum chamber 32A that occurs in the primary molding step stays within a range of, for example, 0 to 10 kPa.

Next, at S15, the control device 7A executes a secondary molding step of raising a pressure in the interiors of the small vacuum chamber 22A and the big vacuum chamber 32A to atmospheric pressure. More specifically, the control device 7A opens the first cutoff valve 57A and further connects the big box pipe 54A and the atmosphere release pipe 52b by means of the three-way valve 56A to establish communication of the small vacuum chamber 22A and the big vacuum chamber 32A with the first tank 52A, raising the air pressure in the interiors of the vacuum chambers 22A, 32A to atmospheric pressure. This bonds the film F to the surface W1 of the workpiece W. In this secondary molding step, when the air pressure in the interiors of the vacuum chambers 22A, 32A is increased to atmospheric pressure, it is preferably increased to atmospheric pressure in as short a time as possible (for example, within one second) so that the pressure difference between the vacuum chambers 22A, 32A is maintained equal to or lower than the pressure difference formed in the primary molding step of S14.

Further, in this secondary molding step, in order to maintain the pressure difference between the vacuum chambers 22A, 32A equal to or lower than the pressure difference formed in the primary molding step of S14 while the air pressure in the interiors of the vacuum chambers 22A, 32A is increased to atmospheric pressure, it is preferable that the edge portions of the film F are cut off by a cutter 25A provided in the interior of the small box 2A, and that communication is established between the small vacuum chamber 22A and the big vacuum chamber 32A before the interiors of the vacuum chambers 22A, 32A are exposed to the atmosphere (see FIG. 8D). This makes it possible to prevent the pressure difference between the small vacuum chamber 22A and the big vacuum chamber 32A from becoming too big while the pressure in the small vacuum chamber 22A and the big vacuum chamber 32A is increased to atmospheric pressure, which makes it possible to prevent deformation of the workpiece W due to the pressure difference while the pressure in the small vacuum chamber 22A and the big vacuum chamber 32A is increased to atmospheric pressure.

Next, at S16, the worker removes the workpiece W with the film F bonded thereto from the big box 3A.

According to the bonding method according to the present embodiment as described above, it is possible to closely bond the film F to follow the shape of the surface W1 of the workpiece W by simply increasing the air pressure in the small vacuum chamber 22A to the second air pressure in a state in which the film F and workpiece W are in contact with each other, which eliminates the need for a manual packing task as in the conventional art. Further, according to the bonding method according to the present embodiment, after pressure has been reduced in the small vacuum chamber 22A and the big vacuum chamber 32A, the small vacuum chamber 22A is increased to the second air pressure that is higher than the first air pressure and lower than atmospheric pressure, before the pressure in the chambers 22A, 32A is increased to atmospheric pressure. Therefore, compared to a case in which pressure in the small vacuum chamber 22A is immediately increased from a vacuum to atmospheric pressure as in the conventional art, the pressure difference between the big vacuum chamber 32A and the small vacuum chamber 22A can be made smaller, which may suppress deformation of the workpiece W when the air pressure in the small vacuum chamber 22A is increased to the second air pressure, which in turn obviates the need for a jig to suppress deformation of the workpiece W.

### EXPLANATION OF REFERENCE NUMERALS

W workpiece (bonding target member)

F film (bonding member)

1, 1A bending apparatus

2 upper box

2A small box (small box body)

22 upper vacuum chamber (second chamber)

22A small chamber (second chamber)

3 lower box

3A big box (big box body)

32 lower vacuum chamber (first chamber)

32A big chamber (first chamber)

B box body

5, 5A air pressure adjustment device

6, 6A movement mechanism

7, 7A control device

1. A bonding apparatus that bonds a thin-membrane-shaped bonding member to a bonding target member, the apparatus comprising:
a box body configured to grip the bonding member inside the box body;
a first chamber and a second chamber demarcated by the bonding member inside the box body;
an air pressure adjustment device configured to adjust an air pressure in the first and second chambers;
a movement mechanism configured to move the bonding target member inside the first chamber; and
a control device configured to control the air pressure adjustment device and the movement mechanism,
wherein the control device reduces the air pressure in the first and second chambers to a predetermined first air pressure lower than atmospheric pressure, then increases the air pressure in the second chamber to a second air pressure higher than the first air pressure and lower than atmospheric pressure in a state in which the bonding member and the bonding target member are brought dose to each other, and then increases the air pressure in the first and second chambers to atmospheric pressure.

2. A bonding apparatus that bonds a thin-membrane-shaped bonding member to a bonding target member, the apparatus comprising:
a small box body configured to grip an edge portion of the bonding member;
a big box body having a first chamber configured to house the bonding target member and the small box body;
an air pressure adjustment device configured to adjust an air pressure in the first chamber and an air pressure in a second chamber demarcated by the bonding member inside the small box body;
a movement mechanism configured to move the small box body or the bonding target member inside the first chamber; and
a control device configured to control the an pressure adjustment device and the movement mechanism,
wherein the control device reduces the air pressure in the first and second chambers to a predetermined first air pressure lower than atmospheric pressure, then increases the air pressure in the second chamber to a second air pressure higher than the first air pressure and lower than atmospheric pressure in a state in which the bonding member and the bonding target member are brought close to each other, and then increases the air pressure in the first and second chambers to atmospheric pressure.

3. The bonding apparatus according to claim 1, wherein the control device increases the air pressure in the second chamber to the second air pressure while maintaining the air pressure in the first chamber equal to or lower than the first air pressure in a state in which the bonding member and the bonding target member are brought close to each other.

4. The bonding apparatus according to claim 1, wherein the control device increases the air pressure in the second chamber to the second air pressure, then establishes communication between the first chamber and the second chamber, and then increases the air pressure in the first and second chamber to atmospheric pressure.

5. A bonding method for bonding a thin-membrane-shaped bonding member to a bonding target member, the method comprising:
a placing step of placing the bonding member inside a box body, demarcating a first chamber and a second chamber with the bonding member as a boundary inside the box body, and placing the bonding target member in the first chamber;
a pressure reduction step of reducing air pressure in the first and second chambers to a predetermined first air pressure lower than atmospheric pressure;
a molding preparation step of bringing the bonding member and the bonding target member close to each other;
a primary molding step of increasing the air pressure in the second chamber to a second air pressure higher than the first air pressure and lower than atmospheric pressure in a state in which the bonding member and the bonding target member are brought close to each other; and
a secondary molding step of increasing the air pressure in the first and second chambers to atmospheric pressure.

6. The bonding apparatus according to claim 2, wherein the control device increases the air pressure in the second chamber to the second air pressure while maintaining the air pressure in the first chamber equal to or lower than the first air pressure in a state in which the bonding member and the bonding target member are brought close to each other.

7. The bonding apparatus according to claim 2, wherein the control device increases the air pressure in the second chamber to the second air pressure, then establishes communication between the first chamber and the second chamber, and then increases the air pressure in the first and second chamber to atmospheric pressure.

8. The bonding apparatus according to claim 3, wherein the control device increases the air pressure in the second chamber to the second air pressure, then establishes communication between the first chamber and the second chamber, and then increases the air pressure in the first and second chamber to atmospheric pressure.

9. The bonding apparatus according to claim 6, wherein the control device increases the air pressure in the second chamber to the second air pressure, then establishes communication between the first chamber and the second chamber, and then increases the air pressure in the first and second chamber to atmospheric pressure.
